(19) United States
(12) Patent Application Publication
(10) Pub. No.: US 2006/0200648 A1
(43) Pub. Date: Sep. 7, 2006

(54) HIGH-LEVEL LANGUAGE PROCESSOR APPARATUS AND METHOD

(76) Inventor: Andreas Falkenberg, 51702 Bergneustadt (DE)

Correspondence Address: DALINA LAW GROUP, P.C., 7910 IVANHOE AVE. #325, LA JOLLA, CA, 92037, US

(21) Appl. No.: 10/906,702

(22) Filed: Mar. 2, 2005

(51) Int. Cl. G06F 9/30

(52) U.S. Cl. 712/214

(57) ABSTRACT

A digital computing component and method for computing configured to execute the constructs of a high-level software programming language via optimizing hardware targeted at the particular high-level software programming language. The architecture employed allows for parallel execution of processing components utilizing instructions that execute in an unknown number of cycles and allowing for power control by manipulating the power supply to unused elements. The architecture employed by one or more embodiments of the invention comprise at least one dispatcher, at least one processing unit, at least one program memory, at least one program address generator, at least one data memory. Instruction decoding is performed in two stages. First the dispatcher decodes a category from each instruction and dispatches instructions to processing units that decode the remaining processing unit specific portion of the instruction to complete the execution.

### BACKGROUND OF THE INVENTION

1. Field of the Invention

Embodiments of the invention described herein pertain to the field of processors, such as a microprocessor. More particularly, but not by way of limitation, embodiments of the invention enable hardware optimized parallel execution of programs compiled from high-level languages using a two stage instruction decoding methodology.

2. Description of the Related Art

A particular processor exposes its available hardware elements via an instruction set that allows for the processor's hardware elements to be exercised. Existing general purpose processors and instructions sets are designed without regard to the high level languages that are to be executed upon the processor's hardware. The instruction set on currently available processors requires a compiler to do all of the optimization work for a program to utilize the hardware. Hence there is an impedance mismatch between the high level programming constructs and the hardware that is to express these constructs through computational methods.

Compilers are generally not advanced enough to take advantage of all of the hardware processor's capabilities. Typically only 20% of the hardware capabilities or instructions associated with a complex processor are utilized through an executable generated by an optimizing compiler. The instructions generally consist of a fixed number of execution cycles and most processors do not have the capability of overlapping instructions since they must be executed in sequence. Hence the compiled executable is mapped to the hardware in the simplest of manners. Thus little or no use is made of 80% of the instructions, for example some of the more complex instructions that are provided for in a commercially available microprocessor as found in a personal computer. This waste of resources requires extra power.

In addition, a high-level language programming construct is typically compiled into multiple assembly language instructions, which shows yet another gap between a program written in a particular software language and the hardware utilized in executing the software executable compiled from the program. This mismatch between the conceptual execution at the high level and the actual execution on the lower level hardware results in relatively slow execution times.

Thus there is a need for a processor which is optimized for the needs and requirements of the high-level programming language that will ultimately be executed by hardware.

### BRIEF SUMMARY OF THE INVENTION

Embodiments of the invention comprise a digital computing component and method for computing that is especially suited to the execution of a high-level software programming language. The architecture employed allows for parallel execution of processing components utilizing instructions that execute in an unknown number of cycles and allowing for power control by manipulating the power supply to unused elements. The architecture employed by one or more embodiments of the invention comprise at least one dispatcher, at least one processing unit, at least one program memory, at least one program address generator, at least one data memory.

The main responsibilities of a dispatcher are to ensure proper execution order of instructions and to assign each instruction to a processing unit. The dispatcher may employ any number of scheduling methods, such as for example an as-soon-as-possible algorithm. The dispatcher allows for parallel execution. One or more embodiments of the invention utilize instructions which comprise an unknown number of execution cycles. Utilizing instructions that comprise unknown execution times allows for better execution of high-level languages. For example, adding two vectors when the vector lengths are not known may be required in a high level language construct. Since the number of elements of the vectors is not known, it is not possible to know the execution time for adding the vectors. Since the dispatcher may dispatch instructions to multiple processing units that execute concurrently, parallel processing is achieved utilizing this architecture. The architecture utilized in embodiments of the invention allow for unused processing elements to be powered down thereby drastically saving power. One or more embodiments of the invention utilize multiple program counters, each corresponding to a separate thread or process. This allows for a high degree of parallelism.

Processing instructions utilizing embodiments of the invention takes place in two stages. First the category of an instruction is decoded by the dispatcher. The particulars of the instruction are not interpreted by the dispatcher but are instead interpreted by the processing unit to which the instruction is assigned. This means that instructions may comprise different formats that may be totally independent of one another and which allow for custom processing units to handle specific instructions. The dispatcher determines from the category of the instruction which processing unit to invoke and the processing unit utilizes the processing unit specific portion of the instruction to execute the intended operation. This subdivision of responsibilities for different portions of the instruction allow for a division of labor that allows for specialization and hence optimization of the resources deployed in specific processors to match the specific high-level language or program that is to be executed in one or more embodiments of the invention.

The main responsibility of a processing unit is to process the processor specific portion of an instruction as received from the dispatcher when the instruction is presented to the processing unit. Processing Units are essentially instruction pipelines. Whatever instruction is required is defined through a processing unit. In a simple case a processing unit may only be an adder, which is attached to a memory unit and in more complex cases may be a fast Fourier transform (FFT) engine or any other functional element that the high-level language constructs of the particular programming language need.

Since the apparatus is capable of interpreting instructions that reflect the high-level language well, a simple compiler may be utilized to compile a high-level language for an embodiment of the invention without optimizing the software executable. Since the hardware is handling the optimizations, the software is not required to be optimized.

### BRIEF DESCRIPTION OF THE DRAWINGS

The above and other aspects, features and advantages of the invention will be more apparent from the following more particular description thereof, presented in conjunction with the following drawings wherein:

FIG. 1 is an architectural view of an embodiment of the invention.

FIG. 2 shows the layout of an instruction utilized by one or more embodiments of the invention.

FIG. 3 shows a flow chart of the method utilized in executing instructions with a processing unit.

FIG. 4 shows the main architecture of a Processing Unit.

FIG. 5 shows the architecture utilized in a pipelined embodiment of the processing unit.

FIG. 6 shows a vector embodiment of a processing unit configured for addition and subtraction of two vectors.

FIG. 7 shows the dispatching of instructions via the dispatcher.

FIG. 8 shows the architecture of Dispatcher.

FIG. 9 shows an embodiment of the compare units shown in FIG. 8.

FIG. 10 shows the inputs and outputs of the ID and priority buffer.

FIG. 11 shows the connections of the basic register element.

FIG. 13A shows an embodiment of the compare unit.

FIG. 13B shows a second embodiment of the compare unit.

FIG. 14 shows an example embodiment configured to support multiple parallel programs which are read from different memories in parallel.

FIG. 15 shows the architecture of the Program Counter Unit/Address Generator.

FIG. 16 shows the data structures used with scalar, vector and matrix versions of instructions for an embodiment of the invention that obtains data type information from memory instead of from the instruction itself.

FIG. 17 shows the virtual time slot assignments involving a branch instruction.

FIG. 18 shows the virtual time step for a binomial formula calculation using vectors.

### DETAILED DESCRIPTION

In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Any mathematical references made herein are approximations that can in some instances be varied to any degree that enables the invention to accomplish the function for which it is designed. In other instances, specific features, quantities, or measurements well-known to those of ordinary skill in the art have not been described in detail so as not to obscure the invention. Readers should note that although examples of the invention are set forth herein, the claims, and the full scope of any equivalents, are what define the metes and bounds of the invention.

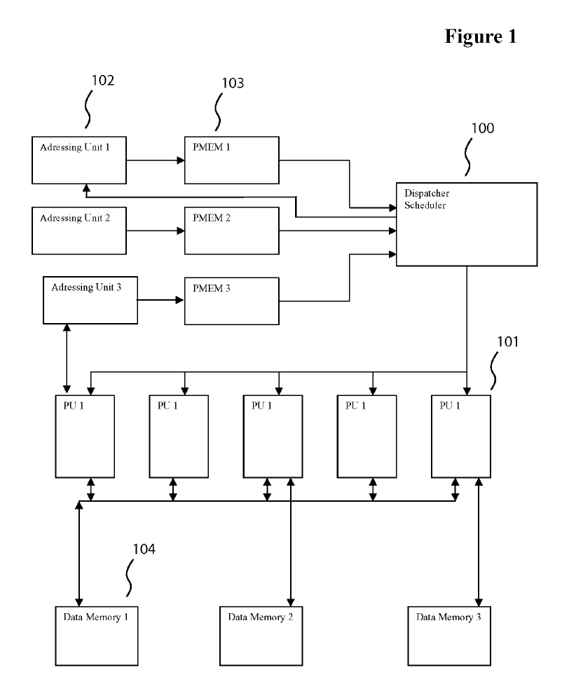

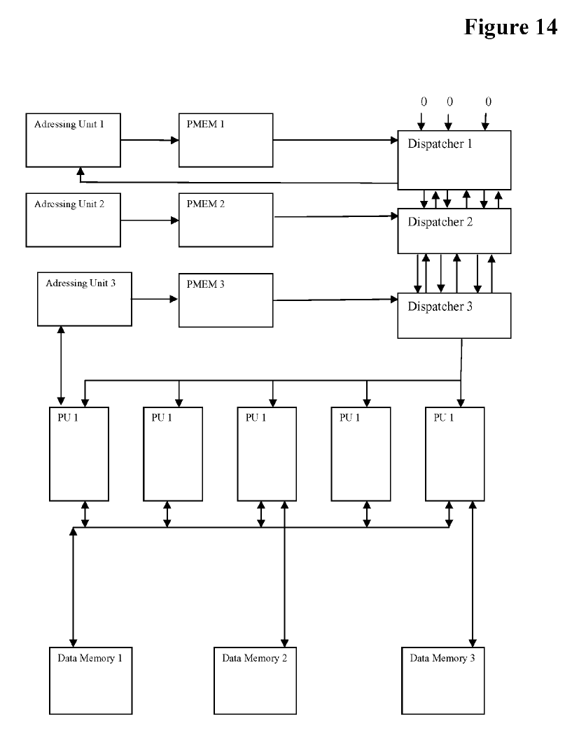

Referring first to FIG. 1, the architecture comprises at least one dispatcher 100 (See FIG. 14 for an embodiment employing more than one dispatcher), at least one processing unit (PU) 101, at least one program address generator 102, at least one program memory 103 and at least one data memory 104. The address units (also known as address generators) 102 (FIG. 1 shows three such elements that are not individually numbered for ease of viewing) provide addresses for reading programs from the program memories. By employing a plurality of independent program memories 103, a program or thread may run in parallel with at least one other program or thread. This allows for a hardware operating system to replace a software operating system since dispatcher 100 is capable of scheduling multiple tasks for execution. Dispatcher 100 (also known as the dispatcher/scheduler) reads instructions from each program memory 103 and delivers the instruction to processing units 101 (of which five are shown with only one numbered for ease of viewing) that are free. The particular instruction target to a processing unit depends on the category of the instruction. It should be noted that any number of processing units is possible with the architecture specified herein. Processing units 101 are generally more intelligent than existing arithmetical or logical units, but not as intelligent as individual microprocessors. Data-memory may be attached to processing units that need to store the results of executed instructions. Some processing units may coupled with more than one data-memory. There are several categories of memory possible, which can be registers with multiple ports, but also fast RAM, slow RAM and so on. The processing-units control the memory access. The processing units are also able to control the program counter units. This means different addressing modes can be defined and added through adding new processing units. In one embodiment one processing unit may be reserved to do the address calculation for indirect branch instructions, which leads to the need to manipulate the program counter. The memory access methods are performed via the processing units as opposed to a program in the program memory. This architecture allows for very complex instructions through custom processing units. The dispatcher is only responsible for the scheduling of the instructions, which it does according to the priority information and a stop-flag while the processing units handle memory access when needed. Although the dispatcher controls the program counter unit, it does not calculate any addresses but stops and releases the address generator/program counter unit in order to generate addresses.

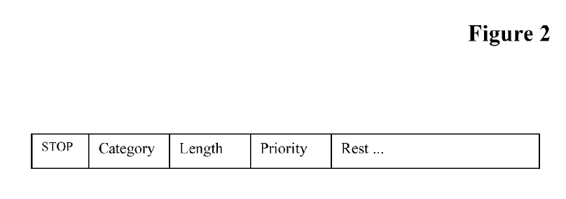

FIG. 2 shows the layout of an instruction utilized by one or more embodiments of the invention. Machine instructions comprise the following features in one or more embodiments of the invention, Flexible Length, Priority assigned to support scheduling, Stop/Wait Flag to show the dispatcher when to stop reading further instructions and Category field. The Category field defines the processing units that are capable of executing the instruction based on available hardware. The dispatcher evaluates the category information and finds the next available processing unit capable of executing this category of instructions. The dispatcher is capable of determining the processing unit capable of executing the instruction since the dispatcher knows which Processing Unit is available, and which processing units are capable of executing instructions of the given category. The Dispatcher delivers the instruction to the processing unit without the category, without the Priority and without the STOP information. The processing unit then performs the instruction. Thus the architecture comprises two levels of interpreting instructions, first through the dispatcher only, then through the processing unit. In addition to the category information the dispatcher uses the priority information and the length information, so that the instruction is delivered to the processing unit in one piece. The “Rest” portion of the instruction contains the final instruction details. In a first step we describe only one addressing and program memory pair. The program-counter is set to a certain location in the appropriate program memory and then the dispatcher reads out the entry in this location and writes the instruction in its own local instruction memory. While doing this the dispatcher interprets the “Length” field of the instruction and continues reading the instruction according to the Length. When the entire instruction is read and settled in the local memory of the dispatcher, the priority and category fields are interpreted. The dispatcher checks all processing units, if they are vacant and if they are able to serve the given category. As soon as one processing unit is free which is able to serve the given category and no other instruction with a higher priority is waiting for the same category, the dispatcher sends the “Rest” of the instruction to the selected processing unit. The processing unit is set to “occupied” thus not accessible for the moment with respect to other instructions. As the instruction is sent to the processing unit an ID is generated, which is stored in a specific register bank, which holds the IDs of actually executed instructions. This will be called ID and priority buffer. In addition the ID is sent also to the processing unit. When a certain instruction has been completed, the appropriate ID is deleted from the ID and priority buffer. Since there is scheduling information available for each instruction, the instruction status needs to be available to the dispatcher/scheduler unit. Instruction execution comprises the following steps. First the address units deliver the next instruction to the dispatcher. The dispatcher obtains the length of this instruction from the length field. The instructions can be delivered to the dispatcher in parallel from the different sources, the dispatcher then puts each instruction into its local instruction memory along with the status and the priority of each instruction. According to the availability of the processing units, the dispatcher delivers the next instruction or several in parallel to the processing units. After the dispatcher has delivered the “Rest” of an instruction to a processing unit it essentially changes the status of that instruction from waiting to executing, which is done through the ID and priority buffer. An instruction is deleted if the processing unit sends a message back that the instruction has completed. If an instruction has the STOP/HALT flag set, the processor does not read further instructions from the memory until all instructions of priority “0” or the highest priority are executed. This enables the architecture to discern time related instruction which allows for the scheduler to schedule instructions and to perform jump and branch instructions. Very complex functions can be defined within the processing unit that corresponds to simple high-level constructs in the programming language targeted for execution via an embodiment of the invention. This is in stark contrast to compiling a high-level language construct into numerous assembly language instructions that must be executed according to the order specified by the compiler.

Processing instructions utilizing embodiments of the invention takes place in two stages. First the category of an instruction is decoded by the dispatcher. The particulars of the instruction are not interpreted by the dispatcher but are instead interpreted by the processing unit to which the instruction is assigned. This means that instructions may comprise different formats that may be totally independent of one another and which allow for custom processing units to handle specific instructions. The dispatcher determines from the category of the instruction which processing unit to invoke and the processing unit utilizes the processing unit specific portion of the instruction to execute the intended operation. This subdivision of responsibilities for different portions of the instruction allow for a division of labor that allows for specialization and hence optimization of the resources deployed in specific processors to match the specific high-level language or program that is to be executed in one or more embodiments of the invention. The main responsibility of a processing unit is to process the processor specific portion of an instruction as received from the dispatcher when the instruction is presented to the processing unit. Processing Units are essentially instruction pipelines. Whatever instruction is required is defined through a processing unit. In a simple case a processing unit may only be an adder, which is attached to a memory unit and in more complex cases may be a fast Fourier transform (FFT) engine or any other functional element that the high-level language constructs of the particular programming language need.

For example, a processing unit may be configured for addition which can add either two scalar values or two vectors. The instruction would for one element look like:
ADDs mem1 [2], mem2[2], mem3[2]

For vectors it would look like:
ADDv mem1 [2], mem2[2], mem3[2], #15

The first instruction above specifies that the contents of memory one, at address two is to be added to the data in memory two at address two and stored in memory three at address two. The second instruction above specifies that 15 elements are to be added starting from address two in memory one and two and stores the result in memory three. This example shows that the two instructions above comprise different lengths although the dispatcher only interprets the controlling portion of the instruction and essentially only knows about the following information:

| | | | |
|---|---|---|---|
| ADD | #3 | #0 | Rest |
| ADD | #4 | #0 | Rest |

In the above scenario, the dispatcher knows how many bytes shall be delivered to the processing unit, which executes instructions of the category “ADD”. The specific definition of the “Rest” portion of the instruction is very open to the individual needs of a certain instruction and as such may vary greatly from instruction to instruction. Through the length and the priority field it is possible to pre-schedule instructions and thus optimize the execution time.

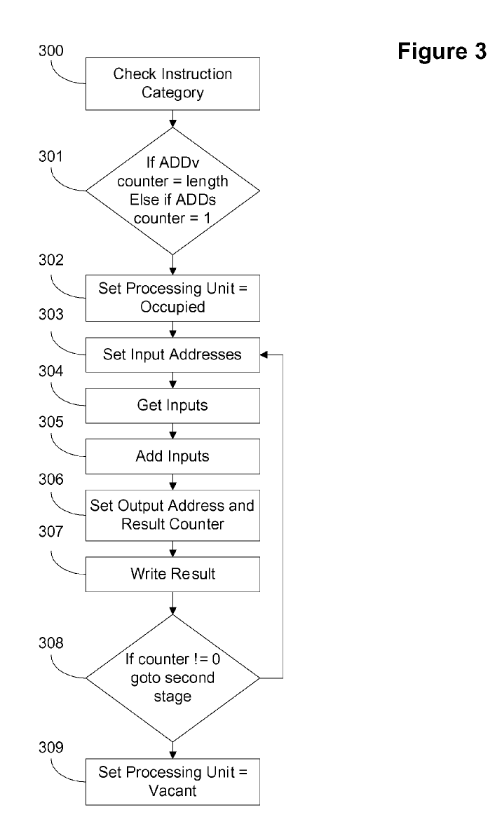

FIG. 3 shows a flow chart of the method utilized in executing instructions with a processing unit through the “Rest” portion of the instruction that is delivered from the dispatcher. The dispatcher determines the category of the instruction at 300. In this example when any category related to ADD is encountered, then the dispatcher sends the instruction to a processing unit that is configured to perform the instruction when the next available processing unit capable of executing this instruction is free. As soon as the dispatcher sends the instruction to the processing unit, it also sets its status to occupied, such that no other instruction can be put to the processing unit. The processing unit can directly be released if the processing is done without a loop in a pipelined manner as may be the case for a simple scalar addition. The processing unit calculates the number of loops to perform at 301. The processing unit sets its status to “occupied” at 302 so that the dispatcher will not attempt to deliver further instructions to it until the processing is complete. The input addresses for the instruction are set at 303 in order to obtain input at 304. The inputs are added at 305 and the output address is calculated at 306 along with the decrementing of the result counter. The result is written at 307 and the counter is checked for non-zero count. If there are more values to add, then the flow branches to 303 to obtain the next set of values to add. If the counter is zero, then the processing unit sets its status to vacant so that the dispatcher may schedule further add instructions for it. Although this example shows addition of scalars and vectors, far more complex operations are possible by utilizing processing units that are more sophisticated. A processing unit may be as complex as an entire microprocessor for example.

Embodiments of the invention allow for power to flow only to processing units that are active. This provides for tremendous power savings as only the processing units that are active are consuming any power.

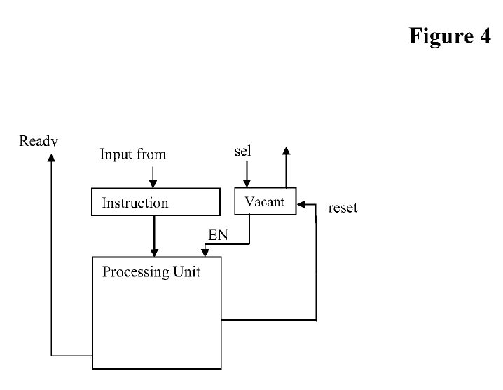

FIG. 4 shows the main architecture of a Processing Unit. So in general an instruction is written by the dispatcher to the instruction register at the same time the select (sel) signal is written into the vacant/occupied flag. When the select signal is set, the vacant/occupied flag changes its status from vacant to occupied. The vacant signal serves also as enable signal for the pipeline. A reset signal resets the status of the processing unit back to vacant, when the next instruction can be scheduled to this processing unit. The ready signal and the vacant signal can be more or less independent to each other, since a processing unit comprising a pipeline is vacant already after one cycle whereas the instruction is not ready yet. On the other hand it is actually possible that the vacant/occupied signal serves as enable signal, which is propagated through the pipeline stages only as needed. The Vacant Flag can be set to occupied by the dispatcher, whereas it is reset to vacant only through the processing unit itself. The main use of the vacant flag is to show the dispatcher if this processing unit is available or not. When it is set to “occupied” then the dispatcher knows that it cannot deliver an instruction to it. It also shows that this processing unit is free, when it is set to “vacant”. At a certain point the processing unit can accept further instructions, which is usually directly possible in the very next cycle, if this processing unit is a pipeline. Thus one of the stages in the pipeline sends the reset signal to the flag, to show that this processing unit is available now. The ready signal by the way is only sent when the instruction is really ready. From the implementation point of view, the vacant flag may well be implemented as a RS-Flip Flop, with the S-input is connected to the “sel” signal and the R input is connected to the “reset” signal.

The instruction register holds all necessary information to execute a given instruction in a processing unit. All of the bits of the original instruction may not be delivered to the processing unit, since decoding is originally performed by the dispatcher. The dispatcher also may have added some information to the instruction, which is necessary for the overall instruction handling. Usually there is no category information and no priority information necessary at this point, since this is completely used only by the dispatcher. Further an ID is assigned for each instruction which identifies the instruction and is used as a ready-ID when this instruction is ready. Normally when the select signal (“sel”) is asserted, the instruction register is enabled to read the input at the next positive (or negative) clock-edge. With the next cycles the instruction is fed through the pipeline and decoded accordingly in the pipeline. Before we come to the details of the pipeline, here is one other signal. The ready or ready ID signal, notifies the dispatcher that a certain instruction is ready. The dispatcher keeps track of the status of each instruction, for example if an instruction is waiting for the next available processing unit, or if it is already running. Since several instructions may run in parallel, a certain ID is given to the processing unit, together with the instruction itself. With the ready signal this ID is sent back to the dispatcher. The dispatcher accordingly removes the instruction from its list of instructions to be executed. Normally the ready ID can just be passed through the pipeline and returned to the dispatcher when the instruction is ready. For resource purposes the dispatcher does not need to keep an entire executing instruction but only its ID. The ID can be an address where the actual parameters of this instruction are stored, for example a register location or any other identifier.

For example if the following instructions are to be supported through one individual component are:
ADD mem[#1], mem[#3], mem[#5]
SUB mem[#2], mem[#4], mem[#6]

The ADD and SUB instructions shown above directly access the specified memory locations which are given through the numbers in brackets.
ADD #1, mem[#2], mem[#3]
SUB #1, mem[#2], mem[#3]

The instruction above specify that a constant value shown as the first parameter is to be added or subtracted with respect to the second value, which is given through its memory location and stored into a memory location specified by the third parameter. Since there are four instructions in this example, two bits are used to encode the operation:
00: ADD mem[#1], mem[#3], mem[#5]
01: SUB mem[#2], mem[#4], mem[#6]
10: ADD #1, mem[#2], mem[#3]
11: SUB #1, mem[#2], mem[#3]

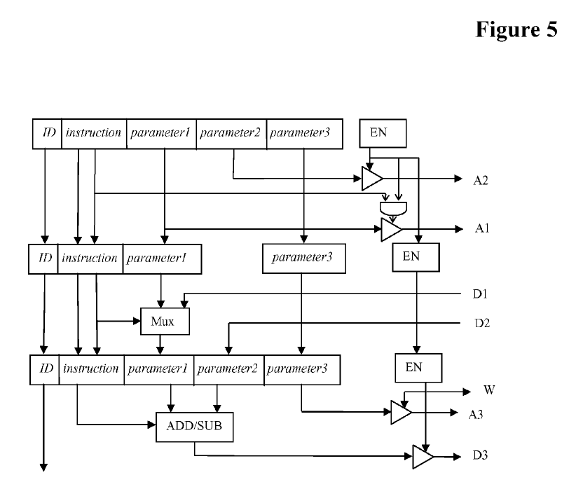

FIG. 5 shows the architecture utilized in a pipelined embodiment of the processing unit. Each stage of the pipeline is shown as an instruction block having an ID as depicted vertically down the figure. Each instruction which arrives at the instruction buffer of the processing unit has the following format:
ID|instruction|parameter1|parameter2|parameter3

The Instruction together with its internal identification (ID) and its parameters is read into the first pipeline registers. The priority and the category is not part of the instruction, since these values have already been interpreted by the dispatcher. In parallel, an enable signal is fed into the pipeline, switching on the next pipeline stage. The second bit is interpreted in the first stage of the pipeline to determine if the first parameter is interpreted as address or as a constant. Together with the enable bit, the parameters one and two are sent as address (A1 and A2) to the memory interface, since they are reflecting the input parameters. Depending on the second bit of the instruction either the first input is fed through to the next stage or it is interpreted as address (A1). By the way the access to the address bus is handled through three-state buffers. The next stage then reads in the returned data from the memory interface via D1 and D2. According to the second bit of the instruction either D1 is taken as input or the parameter 1 directly, which is determined through the Multiplexer (Mux). The third stage now does the final job of calculating the result, which is the addition or subtraction of parameter1 and parameter2. According to the first bit of the instruction either an addition or a subtraction is executed. The parameter3 serves as address for the result which is sent through A3 to the memory interface and the result itself is sent through D3 to the memory interface. Again here the signals are only set through three-stage buffers. A write signal (shown as “W” on the lower right side of the figure) is also generated at this point. The write signal can be connected through a wired OR connection with other writing pipeline-stages. The ID is also send back to the dispatcher to show that the instruction has completed execution and thus can be removed from the list of instructions ready for processing.

This embodiment of a processing unit which comprises a pipeline can execute one instruction per cycle thus the occupied/vacant signal is reset directly to vacant after one cycle.

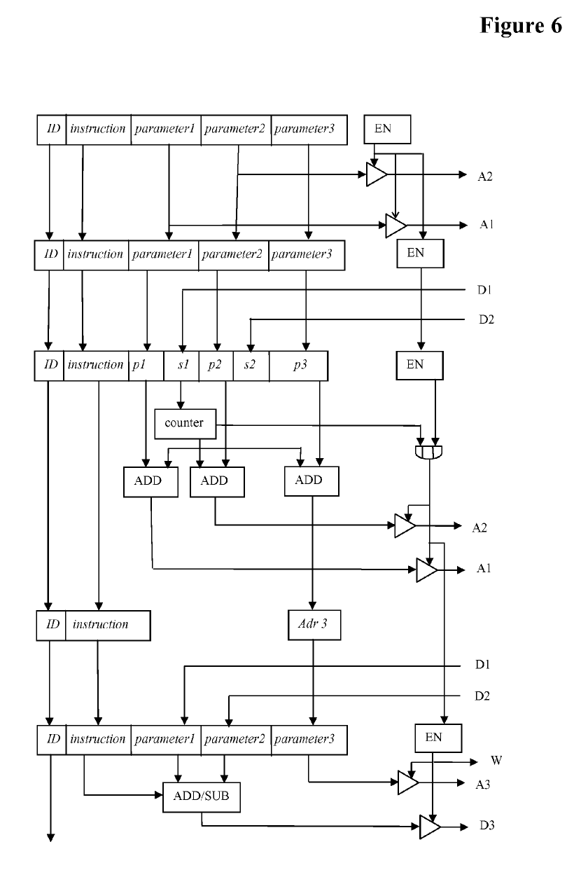

FIG. 6 shows a vector embodiment of a processing unit configured for addition and subtraction of two vectors. The processing unit in this case reads in the starting addresses of the vectors and the first element of a vector signifies the size of a vector. According to the size specified, the appropriate number of elements is read and added. In the first stage of the vector pipeline embodiment of a processing unit, the memory addresses are set, which allows the appropriate data to be read from the data-memory.

Assuming a one cycle delay, the next pipeline stage reads in the data, including the size field comprising the number of elements to be added/subtracted. The counter is set in the third stage according to the size fields. With the address-pointer plus the actual counter-value the actual address of the data is calculated and the memory-address is set accordingly. The data is added which is read from the memory together and stored to the appropriate memory location. The enable signal in the later stages is controlled through the counter, once it is switched on initially. The output from the counter to the OR-Gate is set to ‘1’ as long as the counter runs, thus being not equal to zero. The other output of the counter is the actual value of the counter. The enable signal primarily switches on each stage of the pipeline individually. Once the counter is programmed then the enable signal is controlled primarily through the counter (OR-Gate). The last stage generates the ready ID signal when the enable is switched back to zero. So the ID is only given to the ID output when everything is ready. Although two embodiments have been shown for processing units, the main point is that a ready signal is set in parallel with the ID when the instruction is done regardless of the instruction category implemented by the processing unit. A normal pipeline can always be set to vacant or at least after one cycle, since with every cycle it is possible to deliver a new instruction to that pipeline. The process of developing a pipeline can easily be automated through some simple scripts to generate the appropriate Verilog or VHDL code.

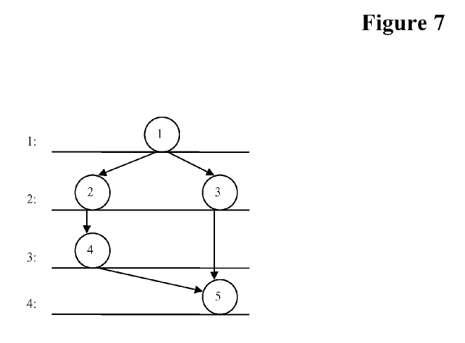

FIG. 7 shows the dispatching of instructions via the dispatcher. The dispatcher supports a scheduling algorithm through the hardware using the priority and STOP information of each instruction. A compiler that can compile a high-level language for scheduling according to an as-soon-as-possible algorithm or an as-late-as-possible algorithm may be utilized with embodiments of the invention. As instructions can have different length and can come from different locations a priority scheme is utilized in order to ensure that the high-level program constructs are supported through the hardware. “As soon as possible” scheduling means that all instructions are scheduled as soon as possible for execution. This means that assuming an indefinite number of resources this would be the fastest possible schedule. Since processing units may be limited, the hardware has to take care of the order within one time step. The instructions are assigned to virtual time slots which are depicted vertically in the figure. The execution starts with the instructions on top and then goes down. It is important to mention that instruction three could very well be scheduled also to virtual time slot 3. But as this example is using the “as soon as possible” algorithm, the instructions are scheduled as soon as they can be scheduled. Since instruction three depends on instruction 1 it can only be scheduled in slot 2 or 3. Given this knowledge instructions are assigned priorities. The following priority definitions are specified through the priority information:

Priority 0 means that this instruction must be executed in the time-slot where it is scheduled.

Priority 1 means that this instruction can be executed up to 1 time-slot later as scheduled.

Priority “n” means that the instruction can be executed up to “n” time-slots later than scheduled.

In the example shown in FIG. 7, instructions 1, 2 and 4 would be assigned priority 0. Instruction number 3 would get priority 1 and instruction number 5 is left unassigned since duration of instructions 2 and 4 may not be known. With this information a dispatcher can be used, which is able to read the priority information and decide accordingly which instruction shall be scheduled next.

The following steps are performed by the reading side of the dispatcher, for an example comprising only one program memory location. The final instruction of each graph comprises a STOP/HALT flag set. This means that all the instructions after this instruction belong to the next time-slot up to the next “STOP” sign.

1. Read Instruction (according to the actual program address)

2. Put the instruction into the waiting list of the dispatcher together with their priorities.

3. If this is the last instruction (the one with the “stop”-flag) of a time-slot, then stop the instruction reading process if there is any instruction left with priority 0.

This process writes the instructions into the local instruction memory of the dispatcher. Another process delivers the instructions to the appropriate processing units. It tries to find a processing unit, which is able to execute the given instruction, whereas higher prioritized instructions are checked first. One additional condition has to be met: After all instructions in the timeslot are executed, the remaining instructions are set one priority higher, (by the numbers it means the number is reduced by one). Then the dispatcher releases the hold signal which was set by the stop-signal, such that the instructions of the next slot can be read.

The dispatcher can schedule the available instructions in any order if an instruction does not depend on another and based on its priority. Instructions of one time-slot which are of priority 0 are executed before other instructions can be read. In one or more embodiments of the invention, the priority of an instruction also increases over time and is adjusted as processing progresses.

Several reader portions of the dispatcher may be utilized for a dispatcher that is configured to work with several program memories. The different programs residing in the different program memories compete for the same processing units. Through the independence of the programs, the overall workload of the processing units shall be much higher. The dispatcher itself checks the availability of the processing units. It reads in the category information and tries to find a processing unit, which is able to execute this instruction, if there is none available, it tries the next instruction from the list. Starting with the higher priority ones and then checking on the lower priority ones. The algorithm utilized by the dispatcher is as follows.

1. The dispatcher goes through all instructions starting with priority 0
a. Then it checks if the appropriate processing unit is vacant
   i. If it is vacant,
      1. then it sets the PU to occupied
      2. It sets the instruction status to executing
      3. It delivers the instruction to the PU but not deleting the instruction from the list.
   ii. If it is occupied
      1. The dispatcher goes back to 1 trying the next instruction.

The processing unit itself sets the status back to vacant when the instruction has completed executing. The dispatcher is then able to delete the instruction from the local instruction memory.

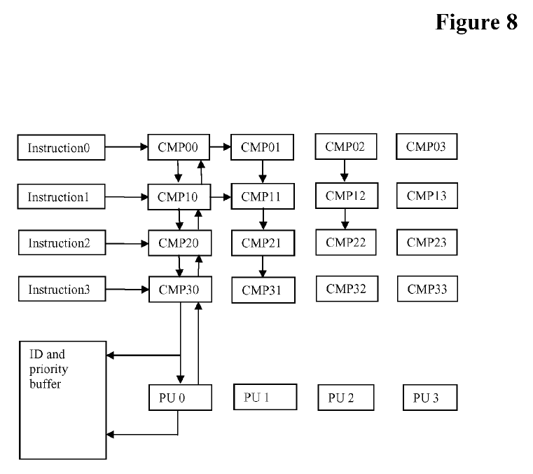

FIG. 8 shows the architecture of Dispatcher. Embodiments of the dispatcher may be configured as a matrix. The matrix on one hand has a set of inputs, which are the instructions given through the program memory. As already shown in the architectural overview all instructions, which are actually active may be executed in any order. These are the instructions, which are already read into the local instruction buffer of the dispatcher. Each instruction has a priority, which is given through the compiler to support the scheduling process. The STOP flag shows the border between the virtual time stamps from group to group. In a perfectly parallel machine, which executes all instructions in only one cycle it would be possible to execute all instructions between two stop signs in parallel. To be more exact: All instructions after an instruction with a STOP flag set until the next instruction with a STOP flag included.

Given that certain instructions require more than one time-step and that certain instructions depend on the results of other instructions, priorities are given to each instruction. A priority of “0” means that the instruction must be executed in its actual virtual time-step. A priority of “1” means that the instruction must be executed in its actual or the next virtual time-step. So the priority shows essentially an interval in which the instruction can be executed starting from 0, which is the actual time-step until the given number. This means that the addressing unit is not allowed to read the next instruction after a STOP flag, if any instructions with priority “0” are still available in the actual local instruction buffer. Also after reading an instruction with a STOP flag, the priorities of all instructions are reduced by one.

An example scenario occurs wherein instruction 1 has priority 2 and which is actually the only instruction in the instruction buffer when the dispatcher reads in another instruction J with priority 1 and a stop flag. In this scenario, all instructions are checked if there is an instruction left over with priority 0, which is not the case. Given that there is no instruction of priority 0 the dispatcher allows the addressing unit just to continue and read in the next instruction. Since a STOP flag occurred the priorities of all instructions in the instruction buffer are reduced by one, thus instruction 1 now has priority 1 and instruction J has priority 0. Further the new instruction K is read into the instruction buffer, which we assume to have also priority 0. As the dispatcher continues it is possible now to start either instruction I, J or K in any order. Although a priority system should prefer the instructions with a higher priority (lower number) it is not clear in which order the instructions are executed. It is possible that instructions of lower priority are scheduled first, if the appropriate processing unit is available.

The instructions are read out of the program memory and stored into one of the instruction buffers (“instruction0” . . . “instruction3”). The instruction buffers hold the priorities. The compare units (CMPxy) compare the instruction-category with the category of the processing unit. In addition the processing unit shows if it is vacant, this bit is also compared. If an instruction category and the processing unit category is equivalent and the appropriate processing unit is free, the instruction can be fed through to the processing unit. This also means that other instructions are blocked, if they fit in the same category at the same time.

As soon as an instruction is sent to a processing unit, it is only necessary to keep an ID of the instruction together with the priority as opposed to the entire instruction. As there is no specific scheme to generate the ID's any method may be utilized so long as a certain ID is only used once at any given time. One possible embodiment may comprise the output of a counter for example that is larger than the total number of instructions that could be executed between STOP bits. The instruction buffer shall generate the ID and the compare-unit shall send it to the ID/Priority Buffer together with the priority of the instruction. As soon as the instruction is ready, which means the processing unit is ready, the ID is deleted from the ID buffer. The instruction itself is deleted from the instruction buffer when it is dispatched to a processing unit. When an instruction with a STOP flag is read, the dispatcher checks ALL priorities, also the priorities of instructions in the ID buffer if there is one which has priority 0. The dispatcher waits as long as it takes until no instruction with priority 0 is available any more. Then the priorities of the instructions and the entries in the ID/Priority buffer are reduced by one. The read process continues. With the next instructions until another STOP flag is read.

Instruction buffers are registers which hold the complete instructions as received from the program memory. A pointer points to the first free instruction-register. Each instruction-register has a flag which shows that this is available. A simple pointer shows the buffer that is the next free buffer and stores the next instruction into this buffer after reading the instruction from memory. Several instructions may be read in parallel, which depends on the exact implementation of the instruction buffer. In FIG. 8 the registers, which belong to the instruction-buffer are shown as “instruction0”, up to “instruction3”, therefore in this example only four instruction-registers are depicted. One register holds the priority and the category and certainly all the details of the instruction. The STOP flag is interpreted right away, such that it is not required to put it in the instruction-registers. Actually the STOP flag is directly interpreted while reading an instruction. In addition to this information the length field also is directly interpreted and needs not to occur also as part of the instruction-registers. Essentially the length field specifies the size of the instruction so that the processing unit knows the size, whereas the address unit does not know the size. The instruction-registers have a flag, which shows that this register is vacant, since the register in itself is not reset to a predefined value, since it is easier and cheaper only to check one bit, than to check the entire entry of a certain register. All instructions in the instruction-registers are parallel available and are compared due to their categories in parallel through the compare components (“CMP00”, up to “CMP33”). In this example only four processing units are shown for the sake of simplicity.

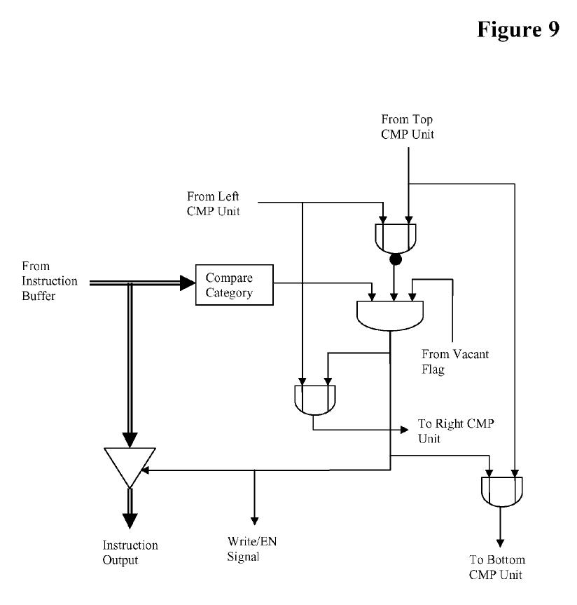

FIG. 9 shows an embodiment of the compare units shown in FIG. 8. The compare units not only compare the instruction category with the processing unit category but also deliver the instruction to the processing unit. The following inputs and outputs are implemented for each compare-unit:
Instruction [with Instruction Category, Priority and ID fields]
Vacant Flag from Processing Unit
Input from Previous (Left) Compare Unit (1 bit)
Input from Top Compare Unit (1 bit)
Output to next (Right) Compare Unit (1 bit)
Output to Compare Unit below (1 bit)
Instruction Output
Instruction Write Signal, which writes to ID/Priority Buffer and Processing Unit

Essentially the single bit messages to the neighbors are utilized to avoid that the same instruction being issued twice to parallel processing units and on the other hand so that two instructions are not delivered at the same time to the same processing unit. Thus an inherent priority can be built up, for example that the top instruction will be first delivered to the left-most processing unit. The “Compare Category” compares the appropriate part of the instruction with the category of the processing unit. The category may either be fed in from the processing unit itself or just be hard-coded into the CMP-Unit. When the instruction fits to the category the output of the compare is set to “1”. So if this is the upper-left CMP-Unit, then the inputs from the left and above should be set to “0”. This means the result of the comparison goes through to the outputs when the processing unit is vacant. The write/EN output is set to “1” which means that the instruction is going through the tri-state buffer and can be written into the first stage of the processing unit, which also is started through this same signal, which is shown through naming it Write/EN. In addition the appropriate parts of the instruction are written into the ID/Priority Buffer and the vacant flag is set back to “O” in the very next cycle. The Write/Enable signal is forwarded to the right neighbor and to the neighbor below if it is “1”, if not the appropriate inputs are forwarded. This essentially means that only one component in a row and in a column can be used at the same time. If the above shown dispatcher with its 4×4 compare units is connected like this, we shall see how a set of instructions is distributed. First for simplicity let us assume that we have four instructions of the same class and also four processing units of the same class, which means that all internal comparisons should lead to a one. This means that all instructions can be dispatched to all processing units. Now we may have a couple of scenarios, first we assume that all processing units are also available. This means that CMP00 generates a “1” at all its outputs, since the “top” input and “left” input are open, which means set to “0”. As the compare is true or “1” the outputs “Write/EN”, “bottom” and “right” are set to “1” also. Also the Instruction is switched through to the output of the tri-state buffer. Now we look at the CMP01 which is the unit to the right. The “top” input is set to “0” since this is the open input, the compare results in a “1”, and the “left” input is set to “1” by CMP00. This means that the “Write/EN” signal is set to “0”, since “left” is already set to “1”. Further it means that the “right” is also “1” but “bottom” is still “0”. We can go to the component CMP11 now. All inputs are “0”, but with a compare of “1” all outputs are again set to “1”. This system allows a dispatcher to be constructed with as many compare units as needed, and inherently the following four targets are achieved:
Each instruction is only issued once to one processing unit
Each processing unit is only used once per cycle
The instruction on the top has the highest priority
The processing-unit to the left is most utilized.

This priority system is a very efficient system which allows expensive, fast, low-power processing units, to be set more to the left and cheap, slow more power consuming more to the right. It is assured that the fast, low-power ones are utilized most. The next component described is the buffer to store the ID and priorities of each instruction. At the same time, when an instruction is issued to the processing unit, the ID and the priority is stored also to the ID/priority buffer, i.e. the write/EN signal is “1” and the instruction is switched through to the instruction output. Depending on the state of the system battery, a decision may be made that switches the default use of the higher power processing units to lower power processing units if the battery is running low. In this scenario a multiplexer may be utilized to cross map the more powerful processing units with the less powerful processing units thereby utilizing a more power efficient strategy when the battery is low.

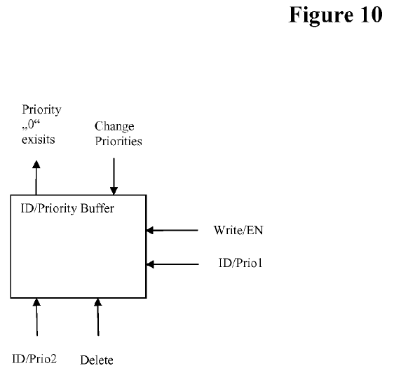

FIG. 10 shows the inputs and outputs of the ID and priority buffer, which essentially holds a set of registers which are used to keep track of the actual instructions and their priorities, which are actually under execution. The figure shows the inputs and outputs of the block. The inputs and outputs are specified as follows:
Priority “0” exists

This output shows that there is at least one instruction, which is under execution that has a priority of “0”, which means the highest priority.
Change Priorities

If this input is set all priorities stored in the ID/Priority buffer are increased (means the value is reduced by one)
Write/EN and ID/Prio 1 input

This output writes the ID and the priority of a newly issued priority into the buffer, the buffer internally generates the address, to store the values at the next available location.
Delete and ID/Prio 2 input

With this input the actual ID and Priority information is deleted from the list, since a certain instruction is ready.

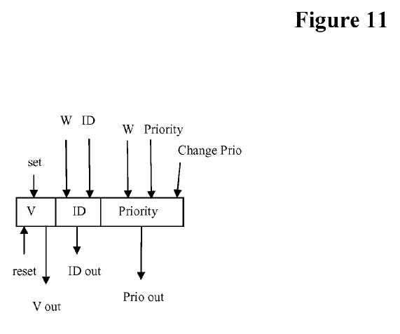

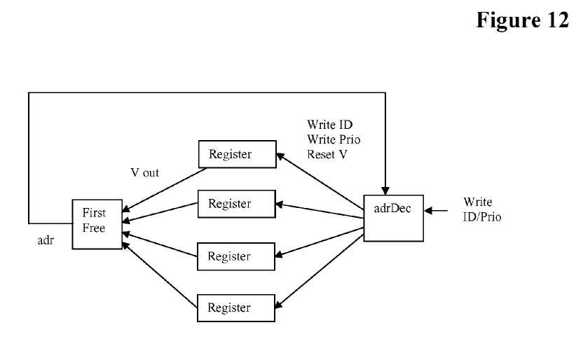

When an instruction is read which has the “STOP” flag, then first of all the “Priority “0” exists” signal is checked. If this signal is “1”, saying that priority “0” instructions are still executing, it is not possible to read in the next instruction. If it is not set or if it turns to “0” then the “change priority” signal is issued for one cycle and set to “1”, which means that all ID-values are reduced by one. The same happens to the instructions which are still in the instruction-buffer. If an instruction is ready then the delete (ready) signal together with the ID/Priority signal is issued, which leads to deleting the entry in the memory. FIG. 11 shows the connections of the basic register element, which allows the following functions:
Read/Write ID
Read/Write Priority
Increase Priority (subtract 1 from the priority)
Set/Reset Vacant Bit
Read Vacant Bit

This is a basic register element, which stores the ID and the priority. There is also an input to change the priority by one, which essentially means that a circuit doing the subtraction by 1 needs to be included. We don't show the details as this is readily implemented through common electro-engineering knowledge.

FIG. 12 shows the environment in which registers are placed. The address is generated through the first-free unit, which means that the address of the first vacant register is addressed. So internally the address can be generated and the ID/Priority pair coming from outside that need not bind to an address initially. The write signal is the same for the ID, the Priority and the Reset of the Vacant Flag. Thus after data is written the Register is not vacant any more.

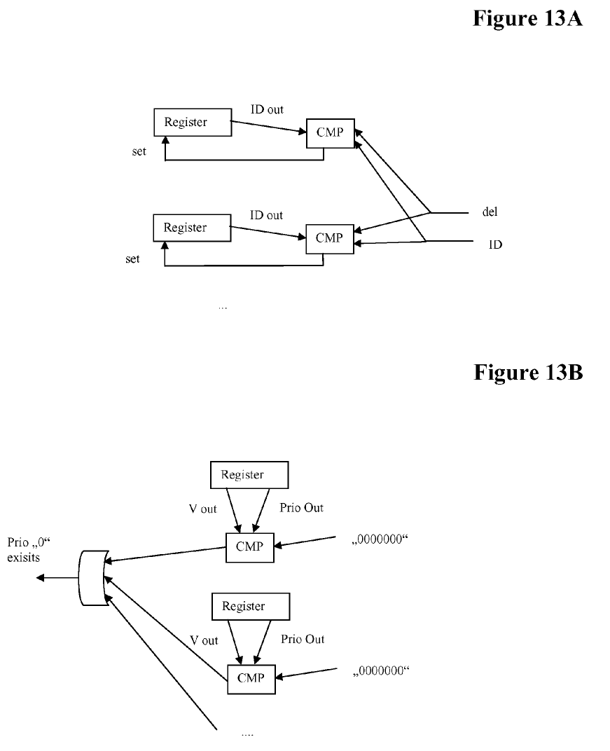

FIG. 13A shows an embodiment of the Compare Unit, which selects the correct ID for deleting. Deleting here means that the vacant flag is set to 1 again, not necessarily setting the entire register to a predefined value. To delete a certain register the V bit is set again, which means that the register is vacant again. To achieve setting the V bit all the Ids in the registers are compared with the input ID. With the del signal and a positive compare the set signal is set to “1” which sets the vacant bit, thus showing that this particular register is available again. The other signals are mapped one-to-many from the outer inputs and outputs to all the appropriate inputs and outputs of the internal registers. Only the “Priority 0 exists” signal, which shows that at least one signal of “Prio Out” does still exist is calculated differently as shown in FIG. 13B in a second embodiment of the compare unit. All priorities are compared with zero, in addition to the V bit which is “0” also, which denotes that this particular Register is used in the moment. If all the bits are “0” then the compare function shall return “1”. All outputs of the compares are combined through an OR gate to show if at least one of the registers holds still a Priority “0”.

FIG. 14 shows an example embodiment configured to support multiple parallel programs which are read from different memories in parallel. Each Memory is connected to its own Dispatcher, meaning that the different dispatchers run entirely in parallel. Access to the same processing unit at the same time is arbitrated by stacking the Matrices with CMP Units on top of each other. The connections between the three dispatcher units are the connections between the CMP Units, which are connected through the “To Bottom CMP Unit” and “From Top CMP Unit”. The first input is again a default “0”.

Parallel Programs can be executed through this architecture, since several address generators and program memory units are available. Each program memory can keep its own individual program, which is independent of the other programs. For this reason the data-memory needs to be subdivided accordingly, such that one program only accesses different memory locations than other programs. The dispatcher may utilize any number of program memories so several dispatchers can run in parallel. The dispatchers may each comprise parallel access to the processing units, such that they all can use every available processing unit. The occupied-flag of the processing unit is visible to all dispatchers. The processing unit “knows” where the instruction came from, such that it can send the “ready” flag to the correct processing unit, after completing one instruction. Certainly the exact parallel access of two dispatchers on the same unit needs to be avoided through some kind of priority system given for the dispatchers. Due to the support of parallel execution units combined with parallel program memories, the execution units certainly are utilized to the fullest amount.

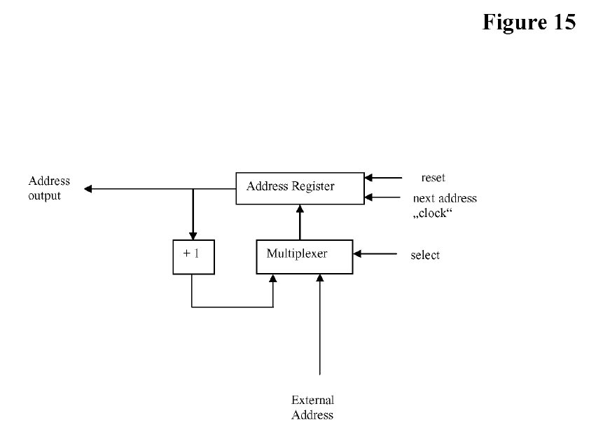

FIG. 15 shows the architecture of the Program Counter Unit/Address Generator. The architecture allows for manipulations of the program counter from external sources rather than providing unneeded internal complexity. Address modes are all controlled externally by one or more processing units. Therefore a brief description of the signals renders the operation of this element clear. The heart of any address generator is the address register of program counter. The program counter holds the address of the actual instruction, which shall been read in the next cycle. Usually each clock cycle the value of the program counter is increased by ‘1’. On each positive (or negative) edge of the clock, which is provided from extern, the address register reads the value which is actually at its input port. The input in our case comes from the Multiplexer. A reset signal may be defined which allows the register to power up into a well defined state, usually zero. The Multiplexer is controlled through an external control signal “select”. This signal chooses either the left or the right input of the multiplexer and delivers the chosen value to the input of the address register. The external signal again can be generated through a processing unit. The select signal chooses between an external address or the next address, which is calculated by adding one to the actual address. The external address can be generated through a processing unit. All processing units, which control the program-counter, shall have an output signal, which are connected via an OR-Gate to the select input. The incrementer-unit adds one to the actual address. This value will be stored into the address-register when the left input of the multiplexer is selected while the positive edge of the clock signal reaches the address register.

The following example shows the essential parts of one or more embodiments of the invention configured to support a high-level language. Specifically, the example shows a few instructions flow through the architecture. Compilers have a difficult task when overloading operators to operate on vectors and matrices as well as scalar variables, all using the same instruction. (Such an example is possible in the C++programming language in addition to other environments).
a=b+c;

This equation is performed using scalar addition, if b and c are scalar variables, whereas the equation is performed using vector addition if b and c are vectors or as a matrix addition if b and c are matrices. For example b and c may be defined as scalars:
b=15;
c=16;

Or as vectors:
b=[13 14 15]
c=[12 14 17]

Or as Matrices
b=[13 14 15; 16 17 18]
c=[12 13 17; 19 21 17]

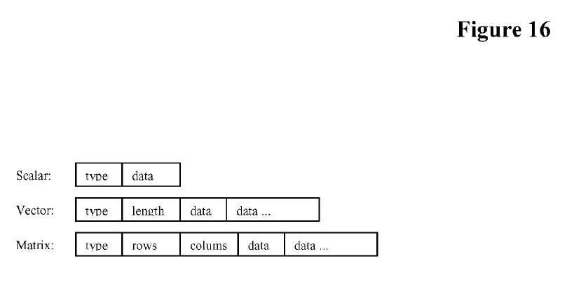

The category of these instructions is “ADD” with two inputs and one output all of which signify memory addresses in this example:
ADD mem[#a], mem[#b], mem[#c]

Where #a shall be the starting address of vector a, #b is the starting address of vector b and #c is the starting address of vector c. Multiple memory banks could be used, but for simplicity it is assumed that only one memory bank is used in this example. As the category is “ADD”, the information about the three memory locations is delivered to the adder. The adder then reads in the memory locations and finds the number of elements of the vectors a, b and c in the memory location, knowing that it has to read the subsequent elements according to this number. These details are all invisible and not of interest to the dispatcher. The adder reads the first elements of “a” and “b” to use and then adds consecutively all the remaining elements and put the results in “c” together for the appropriate number of elements. The processing units may derive type information in any way including from the instruction or as a header on all data items specifying scalar, vector or matrix or any other data type such as complex. The data structure then can be defined shown in FIG. 16, starting with the first memory location for embodiments having type information in memory.

In this example, the type information holds a code, which shows if the following fields are representing a scalar, vector or matrix, or any other type. The length shows the size of the vector in case of the vector type. Whereas in the case of a matrix type there is the number of rows and the number of columns required. The processing unit is fully responsible to define and interpret the instruction correctly and that the system is entirely open to different definitions and type information, since the entire “Rest” Field is delivered to the Processing Unit through the dispatcher. If the fourth element is also delivered to the adder, then regardless of the number of elements of the vector, the adder only adds together the given number of elements, as already shown before. If a, b and c are only scalar then the processing unit also knows this through reading the type information or via the instruction itself.

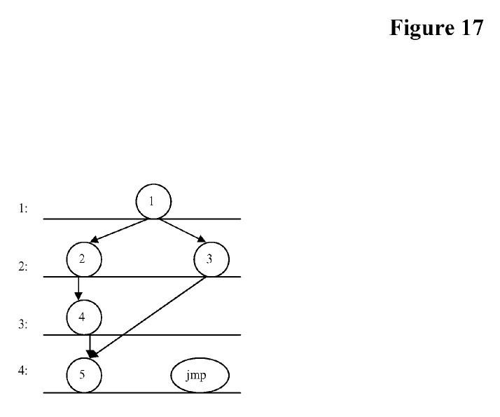

FIG. 17 shows the virtual time slot assignments involving a branch instruction. The dispatcher reads the instructions together with the priority information into the local instruction memory. The last instruction of a certain time-slot is marked with a “stop” flag, which shows the dispatcher that the next instructions can only be read after all instructions of the actual time-slot with priority 0 are already executed. Thus a program which works for any jump and branch instruction may work as depicted in FIG. 17. The figure shows ajmp instruction scheduled on the fourth time-slot. The dispatcher reads in instruction 5 and jmp in parallel, so if both are assigned to be of priority 0 then the dispatcher stops reading further instructions until all the instructions of priority 0 are ready executed. According to the schedule there should be no more instructions in the dispatcher besides these two, so the JMP instruction manipulates the appropriate program-counter value and when it is done the dispatcher tells the addressing unit to read the next instruction.

The main advantages of the shown architecture, if compared to usual RISC or CISC architectures are the following:
(1) The gap between software and hardware is closed
(2) Highly parallel execution through parallel processing units
(3) Complex Functions are directly implemented in Hardware
(4) Reduced Power consumption, since Instructions are handled “locally” only
(5) Open to heterogeneous instruction sets

Usually we have wither RISC like architectures, with primitive instructions the compiler has to take care that the software is optimized, primitive instructions are far away from intended high-level software constructs, thus leaving lots of work to the compiler. It is well known that the gap between hand-coded assembler and compiler generated assembler is usually as large as 2-20 times and maybe even larger for some functions. Through this architecture and approach the gap is closed, since the functions, defined in software are directly reflected through the hardware. Further in other processors usually only one instruction is running in parallel, here the potential parallelism is much higher. The dispatcher only delivers the instructions to the processing units, and then takes care of the next instruction. Therefore the dispatcher does not at all wait until a certain instruction is done, except in the case when a “STOP” flag is set. Hence the architecture is able to execute all processing units in parallel. Complex functions, which are usual in high-level languages, can be directly implemented in hardware, which leads to a high speed with less power consumption. In addition, the power consumption is reduced since individual instructions are handled locally by the processing units. After a certain instruction is assigned to a processing unit, the processing unit is responsible for the execution of that instruction. Furthermore, very heterogeneous instruction sets can easily be implemented herein, which means that the processor really can be adapted to the exact needs of a certain language or even to more specific needs of individual program or customers. For example a customer may want to implement certain functions directly in hardware, which can be easily handled through this processor architecture. Thus the architectural framework enabled herein brings desired flexibility to applications, while maintaining the features of modern processor architecture, which best is reflected through the support of high-level language features.

An example scheduling scenario employing the architecture of an embodiment of the invention follows. Given the need to calculate a binomial formula on vectors of a certain length the following element-wise multiplication, addition and subtraction is employed. For example:
A=[2 4 1 5 7]
B=[1 3 5 8 9]
X=A*A−2*(A*B)+B*B

The operators perform element-wise multiplication, addition and subtraction, thus the result in X is also a vector:
X=[1 1 1 6 9 4]

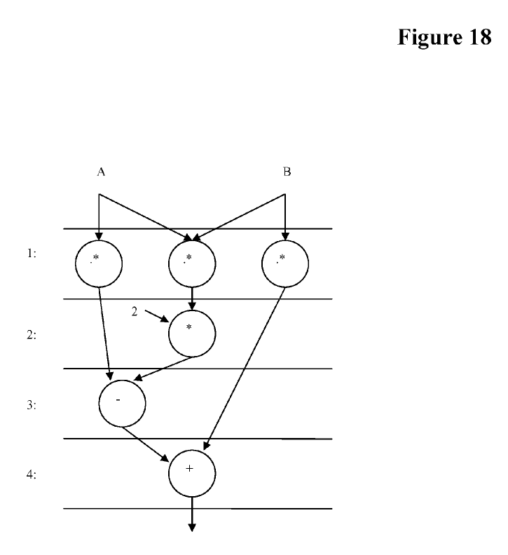

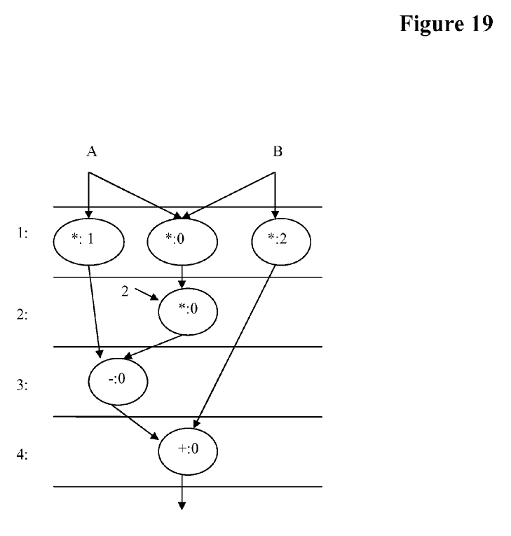

FIG. 18 shows the virtual time step for a binomial formula calculation using vectors. The exact duration of each instruction is unknown a priori, however the instructions can be compiled into time steps. All operations are element-wise, except the multiplication with the constant 2. “Time” runs from top to bottom. No optimization is performed in this example and the time steps chosen are via an “as soon as possible” algorithm. This example shows the dependencies and the order in which instructions are performed. Priorities are generated to indicate the interval in which a certain instruction can be executed. The priorities are shown as numbers to the left besides the instructions. Each instruction which is required to be executed in the actual time step is assigned a priority of zero (0). An instruction that can be delayed by one time step is assigned a priority of one (1) and in this example the priority two (2) is assigned to the multiplication on the right since the instruction may be executed in the actual time step, in the second or in the third time step. In this example, the interval starts with the actual time step and ends with the actual time step plus the largest priority. The instructions within the same time step can be represented in any order. With all the instructions working on vectors the total time to execute an instruction is unknown during the compilation phase.
H1=A*A
H2=A*B
H3=B* B
H4=2*H2
H5=H1−H4
X=H5+H3

The following order of the instructions is possible as well on a per time step basis:
H2=A*B
H1=A*A
H3=B* B
H4=2*H2
H5=H1−H4
X=H5+H3

With priorities and also the timestamps, the instructions look for example as follows (using an extra stop sign to show the borders between the time steps):
H1=A*A prio=1
H2=A*B prio=0
H3=B*B prio=2

STOP here starts the next timestamp
H4=2*H2 prio=0

STOP
H5=H1−H4 prio=0

STOP
X=H5+H3 prio=0

The STOP flag comprises one bit in the instruction.
H1=A*A prio=1 STOP=0
H2=A.*B prio=0 STOP=0
H3=B*B prio =2 STOP =1
H4=2*H2 prio=0 STOP=1
H5=H1−H4 prio=0 STOP=1
X=H5+H3 prio=0 STOP=1

Here once again the same with an other order in the first timestep:
H3=B.* B prio=2 STOP=0
H1=A.*A prio=1 STOP=0
H2=A.*B prio=0 STOP=1
H4=2*H2 prio=0 STOP=1
H5=H1−H4 prio=0 STOP=1
X=H5+H3 prio=0 STOP=1

Each instruction may run for several cycles, not only one cycle. Also the element-wise vector multiplication and the multiplication with the constant 2 may run for different cycles.

In this example, vectors of length 5 are utilized although any length of vector may be utilized in the system. For this it is assumed that the multiply functions require 20 clock cycles, that the 2*H2 instruction requires only 10 cycles and that − and + require 5 cycles each. Further it is assumed that per each cycle one instruction is read and therefore the example does not show parallelism for simplicity of illustration of the architecture.
1: H1=A.*A prio=1 STOP=0
2: H2=A.*B prio=0 STOP=0
3: H3=B*B prio=2 STOP=1
4: H4=2*H2 prio=0 STOP=1
5: H5=H1−H4 prio=0 STOP=1
6: X=H5+H3 prio=0 STOP=1
The processing occurring in each cycle is as follows:

Cycle1:
Read Instruction 1
Put Instruction 1 into the Waiting List (Instruction Buffer)

Check for STOP bit→it is 0 we continue reading instructions.

Cycle 2:
Read Instruction 2
Put Instruction 2 into the Waiting List (Instruction Buffer)
Check for STOP bit→it is 0 we continue reading instructions.

The dispatcher finds a processing unit, which can perform Instruction 1.
(Note that Inst 2 has a higher priority, i.e, zero (0) than the instruction which is taken)

The priority and the ID of Instruction 1 (ID=1) is stored into the ID/Prio Buffer.

The multiplier processing unit is set to occupied and also the ID together with the rest of the instruction is given to the multiplier processing unit.

Cycle 3:
Read Instruction 3
Put Instruction 3 into the Waiting List (Instruction Buffer)
Check for STOP bit→it is 1 now!!!
   Instruction 1 is still running

Cycle 4:

The STOP flag is set now, so we check if an instruction of prio=0 is either in the Instruction Buffer or is already running, which means an ID/Prio pair with prio=0 exists in the ID/priority Buffer.

In this case we find the prio=0 in the Instruction Buffer.

As this is the case don't read further.
In the Instruction Buffer we find Instruction 2 with Prio=0.

Cycle 5:

Same as 4

Cycle 6:

. . .

Cycle 21:

Same as 4

This is the last cycle of Instruction 1 (=20 cycles), the multiplier processing unit is free after this cycle.
The pair of ID=1/prio=1 is cleaned out of the ID/Priority buffer.

Cycle 22:

The dispatcher checks if there is a processing unit available for inst 2, which is the case now.

The Instruction with the higher priority (lower number) is assigned to the multiplier processing unit, which is Instruction 2 with Prio=0.

The ID 2 and the Prio is stored into the ID/Priority buffer.

As the STOP bit is still set, the Priorities are checked in both buffers, which means that no new instruction is read.

Cycle 23:
Same as 4, but an instruction with prio=0 is already running, such that the information is now found in the ID/Prio buffer and not in the Instruction Buffer.

Cycle 24:
Same as 23

Cycle 25:

Cycle 41:
Last cycle of Instruction 2, so the PU is freed at the end of this cycle.
The ID 2 of the ID/Priority Buffer is cleaned at the end of this cycle.

Cycle 42: (maybe split into two real cycles)
The STOP bit is still set, we check if there is an instruction of prio=0 still there in the instruction buffer.

This is not the case, since only Instruction 3 is there with prio=2.

So we reduce all priorities in the Instruction AND in the ID/Prio Buffer by one.

Instruction 3 gets now Prio=1.

The stop bit is reset now.

Further a free multiplier processing unit is available, where Instruction 3 is assigned to.

Thus ID=3 with prio=1 is put into the ID/Prio buffer.

Instruction 4 is read into the Instruction Buffer

This means the STOP bit is set again.

Cycle 43
Check the STOP bit, as it is 1 we need to check if an instruction of prio 0 is there.
Yes we have Instruction 4 here so we can not read another instruction

The constant multiplier processing unit is free such that Instruction 4 is assigned to the constant multiplier processing unit.
ID 4/Prio=0 is stored in the ID/Prio Buffer

Cycle 44

. . .

Cycle 52:

Instruction 4 (==10 cycles) is ready here
Clean the ID 4/prio=0
Free the constant* PU

Cycle 53:
STOP bit is still set, so check if there is any instruction with prio 0.
There are none as Instruction 4 is ready now.
We reduce all priorities in Instruction Buffer and ID/Prio Buffer by 1
Thus Instruction 3 is set to prio=0
Reset the stop sign

Instruction 5 is read into the Instruction Buffer
STOP sign is set again.

Cycle 54
Check the STOP sign→it is set

Since Inst 5 has prio 0 there is no new instruction to be read
Instruction 5 is assigned to the minus−PU
ID 5/prio=0 is stored into the ID/Prio Buffer

Cycle 55

. . .

Cycle 58

Last cycle of Instruction 5 (=5 cycles)
ID 5 is deleted
Minus PU is free

Cycle 59
STOP sign is still set
Instruction 3 has prio 0, so no new instruction can be read

Cycle 60:

. . .

Cycle 61:
Instruction 3 is ready (=20 cycles)
Multiplier processing unit is freed
ID=3 is cleaned

Cycle 62
STOP sign is set so we check for prio=0→none so we reset STOP sign
Read Instruction 6

Cycle 63
Assign Instruction 6 to plus PU

. . .

While the invention herein disclosed has been described by means of specific embodiments and applications thereof, numerous modifications and variations could be made thereto by those skilled in the art without departing from the scope of the invention set forth in the claims.

What is claimed is:

1. A high-level language processor comprising:
at least one dispatcher;
at least one processing unit;
at least one addressing unit;
at least one program memory;
at least one data memory;
an instruction read from said at least one data memory;
said at least one dispatcher configured to read a category from said instruction obtained via said at least one program memory through an address calculated by said at least one addressing unit, wherein said at least one dispatcher is configured to pass a remaining portion of said instruction to said at least one processing unit if said at least one processing unit is not occupied and wherein said at least one processing unit is configured to execute said remaining portion of said instruction and place a result in said at least one data memory and wherein said dispatcher is configured to decrement a priority associated with a second instruction and not execute another instruction until a third instruction comprising a STOP bit is completed; and,
said at least one processing unit configured to power off if no instruction is executing in said at least one processing unit.

2. The high-level language processor of claim 1 wherein said instruction comprises data type information.

3. The high-level language processor of claim 1 wherein said at least one data memory comprises data type information.

4. The high-level language processor of claim 1 further comprising:
said dispatcher configured to ensure proper order of execution of said instruction.

5. The high-level language processor of claim 1 further comprising:
said dispatcher configured to dispatch instructions utilizing a as-soon-as-possible algorithm.

6. The high-level language processor of claim 1 further comprising:
a compiler that does not optimize an executable generated from a high-level programming language.

7. The high-level language processor of claim 1 further comprising:
said at least one dispatcher comprising at least one comparison unit wherein said at least one comparison unit is configured into a matrix and wherein said at least one comparison unit allows for faster processing units to be configured for more frequent use.

8. The high-level language processor of claim 1 further comprising:
said at least one dispatcher comprising at least one comparison unit wherein said at least one comparison unit is configured into a matrix and wherein said at least one comparison unit allows for lower power processing units to be configured for more frequent use.

9. The high-level language processor of claim 1 further comprising:
said at least one dispatcher comprising at least one comparison unit wherein said at least one comparison unit is configured into a matrix and wherein said at least one comparison unit allows for faster and lower power processing units to be configured for more frequent use depending on the state of the system battery.

10. The high-level language processor of claim 1 further comprising:
said at least one dispatcher comprising a first dispatcher and a second dispatcher configured to run in parallel.

11. A method of utilizing a high-level language processor comprising: creating at least one dispatcher;
coupling at least one processing unit to said at least one dispatcher;
coupling at least one addressing unit to said at least one dispatcher;
coupling at least one program memory to said at least one dispatcher and said at least one addressing unit;
coupling at least one data memory to said at least one processing unit;
calculating an address with said at least one addressing unit;
obtaining said instruction from said at least one program memory at said address;
decoding a category from said instruction via said at least one dispatcher;
determining if said at least one processing unit is not occupied;
passing a remaining portion of said instruction to said at least one processing unit;
executing said remaining portion of said instruction via said at least one processing unit;
generating a result in said at least one data memory;
decrementing a priority associated with a second instruction choosing to not execute another instruction until a third instruction comprising a STOP bit is completed; and,
powering said at least one processing unit off if no instruction is executing in said at least one processing unit.

12. The method of claim 11 further comprising:
obtaining data type information from said instruction.

13. The method of claim 11 further comprising:
obtaining data type information from said at least one data memory.

14. The method of claim 11 further comprising:
ensuring proper order of execution of said instruction.

15. The method of claim 11 further comprising:
dispatching instructions utilizing a as-soon-as-possible algorithm.

16. The method of claim 11 further comprising:
compiling a high-level programming language using a compiler without optimizing an executable generated from said high-level programming language.

17. The method of claim 11 further comprising:
configuring at least one comparison unit within said at least one dispatcher into a matrix wherein said at least one comparison unit allows for faster processing units to be configured for more frequent use.

18. The method of claim 11 further comprising:
configuring at least one comparison unit within said at least one dispatcher into a matrix wherein said at least one comparison unit allows for lower power processing units to be configured for more frequent use.

19. The method of claim 11 further comprising:
configuring at least one comparison unit within said at least one dispatcher into a matrix wherein said at least one comparison unit allows for faster and lower power processing units to be configured for more frequent use depending on the state of the system battery.

20. The method of claim 11 further comprising:
configuring said at least one dispatcher as a first dispatcher and a second dispatcher configured to run in parallel.
